(19) United States
(12) Patent Application Publication
(10) Pub. No.: US 2006/0219370 A1
(43) Pub. Date: Oct. 5, 2006

(54) Window covering having folding shade elements

(76) Inventor: David Pon, Irvine, CA (US)

Correspondence Address: BUCHANAN INGERSOLL & ROONEY PC, P.O. BOX 1404, ALEXANDRIA, VA, 22313-1404, US

(21) Appl. No.: 11/096,601

(22) Filed: Apr. 1, 2005

(51) Int. Cl. E06B 9/30

(52) U.S. Cl. 160/168.1 R

(57) ABSTRACT

A window covering has a series of spaced apart, slat-like shade elements. Each shade element has a flap extending from one or both longitudinal edges of the shade elements. The space between adjacent shade elements is greater than the width of the shade elements and less than or equal to the width of the shade element plus the width of the flap. Cords are attached to the longitudinal edges of the shade elements so that the shade elements can be tilted or folded relative to the flaps. A panel of sheer material can be used in addition to or in place of the cords.

### BACKGROUND OF THE INVENTION

1. Field of the Invention

The present invention relates generally to window blinds of the type having tilting shade elements, such as the slats in a venetian blind.

2. Description of the Related Art

Venetian blinds are one type of popular window covering. These blinds have a headrail, a bottom rail, and ladders extending between the bottom rail and the headrail that support a series of slats. Lift cords extend from the bottom rail into the headrail for raising and lowering the blind. The slats are tilted by movement of the ladders.

The slats can be raised to a fully open position, lowered to cover the entire window and tilted vertically to a fully closed position or lowered to a fully lowered or partially lowered position with the slats tilted at a selected orientation between vertical and horizontal. In a venetian blind the spacing between slats does not exceed the width of the slats and is usually less than the width of the slats. Such spacing is required so that the blind will fully cover the window when the slats are tilted to a vertical or near vertical position. Because of this spacing there are no gaps between the slats when they are in a fully tilted vertical or near vertical position.

Although the slats in most venetian blinds are wood, aluminum or plastic, it is known to make fabric slats. One example of a fabric slat is disclosed in U.S. Pat. No. 5,829,506 to Zorbas. Like wood, aluminum and plastic slats, fabric slats are hung on ladders or attached to ladder rungs and may have transverse stiffeners. Venetian blinds having fabric slats operate in the same manner as venetian blinds having wood, aluminum or plastic slats.

Kandel in U.S. Pat. No. 3,388,490 discloses a venetian blind having a fringe attached to one edge of each slat. The fringe extends to the next adjacent slat covering the space between the slats for privacy but allowing air to pass. Nien discloses a venetian blind having a mesh fabric attached to either or both longitudinal edges of the slats in United States Published Patent Application No. 2004/0016693. Like the other venetian blinds in the prior art the spacing between adjacent slats in the blinds disclosed by Kandel and Nien does not exceed the width of the slat. Consequently, when the slats are moved to a fully tilted, vertical or near vertical position there will be no space between adjacent slats through which light may pass. Therefore, these blinds provide the same type of light control as a conventional venetian blind.

### SUMMARY OF THE INVENTION

I provide a window covering having a headrail, two or more lift cords extending from the headrail and several slat-like shade elements of selected width positioned sequentially below the headrail. Each shade element may have apertures through which the lift cords pass. Unlike a conventional venetian blind, adjacent shade elements in the present invention are spaced apart a greater distance than the width of the shade element or slat. The shade elements are substantially parallel to one another and oriented transverse to the lift cords. A flap is attached to one or both longitudinal edges of each shade element. The width of each shade element plus the width of the flap is not less than the spacing between adjacent shade elements. When the shade elements are in a closed position the lower edge of one flap is opposite or abuts the upper edge of an adjacent shade element so that there is no gap in the window covering through which light may pass. When the shade elements are in an open position, the lower edge of the flap is spaced apart from the adjacent shade element. Movement of the shade elements is controlled by a first cord or cords attached to one longitudinal edge of each shade element and extending into the headrail and a second cord or cords attached to the opposite longitudinal edge of each shade element. In one embodiment the upper end of the each cord is fixed to the headrail. Pulling or releasing the second cords raises or lowers the longitudinal edge of the shade elements to which the second cords are attached closing or creating a gap between the shade elements and adjacent flaps. In another embodiment both the first cords and the second cords are movable relative to the headrail. Therefore, either or both longitudinal edges of the shade elements can be raised or lowered. As the shade elements move the flaps remain in a substantially vertical position such that the shade element can be said to fold relative to the flap. One could connect both cords to a drum or shaft which when rotated will move the edges of each shade element in opposite directions.

In addition to the first and second cords that are attached to the longitudinal edges of the shade elements, lift cords extend from the headrail to the lowermost shade element or the bottom rail, if a bottom rail is present. The lift cords raise and lower the shade elements just as the lift cords in a venetian blind raise or lower the slats.

The shade elements may be wood, aluminum, woven wood or vinyl, but preferably are fabric. The flaps also are preferably fabric, but they could be a woven wood or film. In one embodiment the shade elements and flaps are the same fabric. In another embodiment two flaps are provided, one flap being a mesh fabric through which light may pass and the second fabric being an opaque material which blocks light.

One may also configure the present shade as a top down, bottom up shade. In one embodiment of this type of shade all the cords pass through cord locks allowing the shade elements to be lowered and stacked on a bottom rail or window sill. Another embodiment of a top down, bottom up shade uses an intermediate rail. The cords that attach to the edges of the shade elements are attached to or pass through the intermediate rail.

One may provide a panel or two panels of sheer material extending from the headrail. The panel of sheer material can be used in addition to or in place of the cords that are attached to the longitudinal edges of the shade elements.

Other objects and advantages of the present window covering will become apparent from certain present preferred embodiments thereof shown in the drawings.

### BRIEF DESCRIPTION OF THE DRAWINGS

FIG. 1 is a perspective view of a first preferred embodiment of the present invention in a fully lowered, first open position.

FIG. 2 is a perspective view of the embodiment of FIG. 1 in a fully lowered, second open position.

FIG. 3 is a perspective view of the embodiment of FIG. 1 in a fully lowered, closed position.

FIG. 4 is a side view of the embodiment of FIG. 1 in the first open position.

FIG. 5 is a side view of the embodiment of FIG. 1 in a fully lowered, closed position.

FIG. 6 is a perspective view of a second preferred embodiment of the present invention in a fully lowered, fully open position.

FIG. 7 is a perspective view of the embodiment of FIG. 6 in a fully lowered, first closed position.

FIG. 8 is a perspective view of the embodiment of FIG. 6 in a fully lowered, second closed position.

FIG. 9 is a perspective view of a third present preferred embodiment of the invention in a fully lowered, fully open position.

FIG. 10 is a side view of a preferred embodiment in a fully lowered, first closed position.

FIG. 11 is a side view of the upper portion of the embodiment shown in FIG. 9.

FIG. 12 is a front view of a fourth present preferred embodiment in a fully lowered closed position.

FIG. 13 is a front view of the embodiment of FIG. 12 in a lowered open position.

FIG. 14 is a front view of an upper portion of a sixth present preferred embodiment, which is similar to the embodiment shown in FIGS. 9, 10 and 11.

FIG. 15 is a perspective view of a seventh preferred embodiment of the present invention in a fully lowered, first open position.

### DETAILED DESCRIPTION OF THE PREFERRED EMBODIMENTS

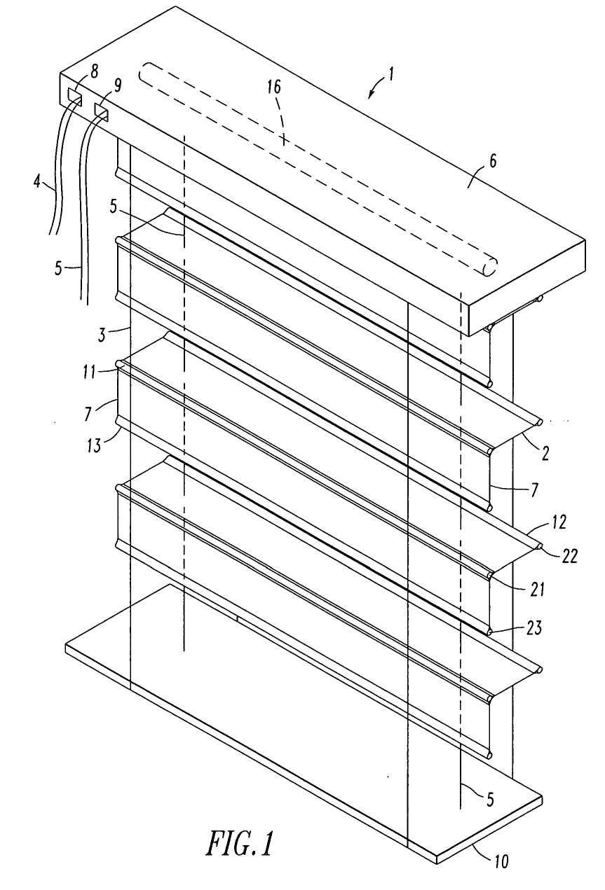

A first present preferred embodiment of my window covering is shown in FIGS. 1 through 5. This window covering 1 is comprised of a headrail 6, a plurality of operable shade elements 2, two first cords 3, two second cords 4 and two lift cords 5, all of which extend into the headrail 6. The shade elements 2 could be wood, woven woods, aluminum, vinyl or other plastic, but preferably are fabric or film. Any fabric that has traditionally been used in a window coverings could be used including natural materials, such as silk, cotton and linen, synthetic materials such as polyester, rayon and nylon, or a blend of natural and synthetic materials. The fabric could be woven or non-woven. Preferably the material has a weave that is sufficiently tight so that light does not pass through the material. Each shade element 2 has a first longitudinal edge 11 to which a first stiffening rod 21 is attached, and a second longitudinal edge 12 to which a second stiffening rod 22 is attached. The rods 21 and 22 extend the full length of the operable shade element 2. A flap 7 extends from the first longitudinal edge 11 of the shade element 2. The flap may be the same material as the shade element. Accordingly, a third stiffening rod 23 is provided along the lower edge or free edge 13 of the flap 7. Preferably the flaps 7 and the shade elements 2 have the same width. That width preferably is between about 2 inches and 6 inches (5 cm to 15 cm) and most preferably is 4 inches (about 10 cm). The spacing between adjacent shade elements is always greater than the width of the shade element and is not more than the width of the shade element plus the width of the flap.

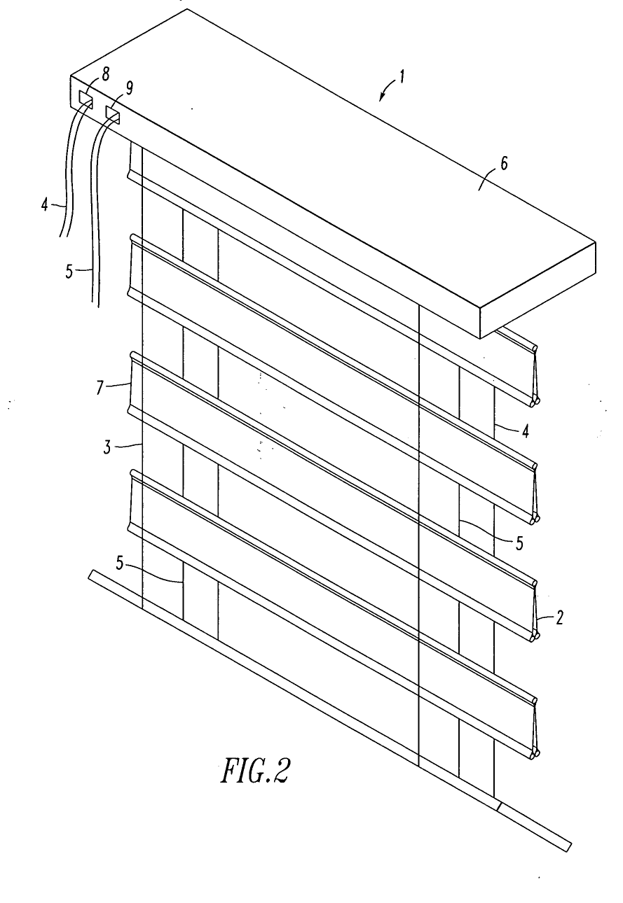

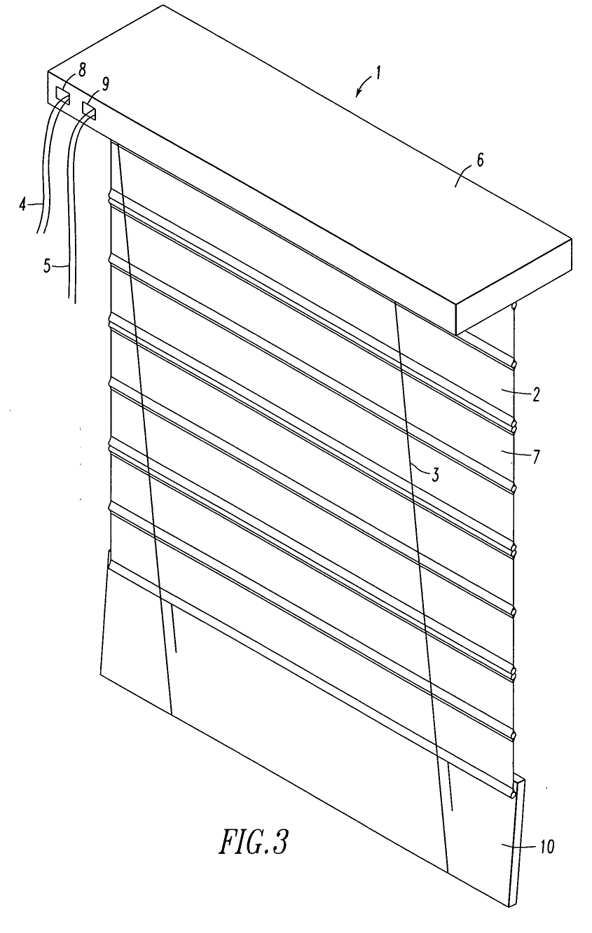

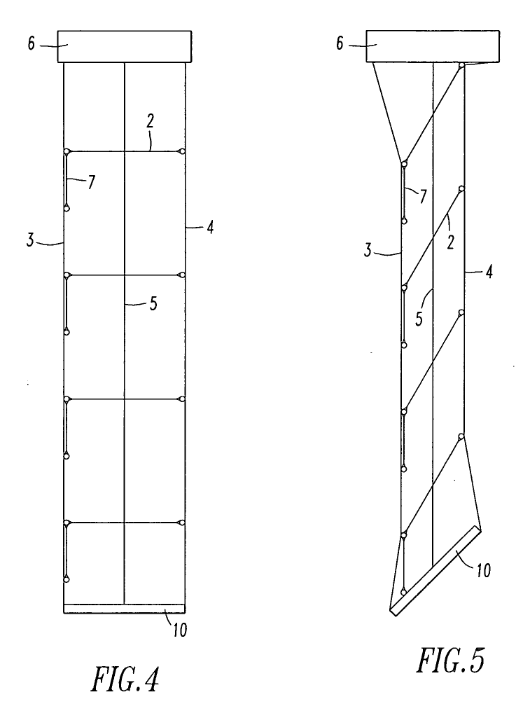

In the first present preferred embodiment, the upper ends of the two first cords 3 are fixed to the headrail 6. These cords are also attached to the first longitudinal edge of each shade element 2. In an alternative embodiment the first cord may be connected to a shaft 16 shown in dotted line in FIG. 1 or other operating mechanism within the headrail 6. The second cords 4 are attached to the opposite longitudinal edge 12 of each shade element 2. The second cords 4 pass through a cord lock 8 in the headrail 6. Pulling the second cords 4 will raise the second longitudinal edge 12 of the shade elements from the position shown in FIG. 1 to the fully closed position shown in FIGS. 3 and 5. Releasing cords 4 from the cord lock 8 will enable the second longitudinal edge of the shade elements to fall to the second open position shown in FIG. 2. Of course, one could raise or lower the second longitudinal edge to any selected position intermediate the second open position shown in FIG. 2 and the fully lowered, closed position shown in FIG. 3. Accordingly, the size of the gap between shade elements and adjacent flaps is determined by how much the edge of the shade element 2 is raised. If desired, one could fix the upper ends of cords 4 to the headrail and pass cords 3 through the cord lock 8. Then the shade would be moved to a fully lowered, closed position by lowering the first longitudinal edges of each shade element. One could also raise the first longitudinal edges of the shade elements so that the shade elements are positioned as shown in FIG. 4. Yet, another alternative is to connect both the first cords 3 and the second cords 4 to a shaft 16 in a manner so that both edges of the shade elements and rods 21 and 22 would move in opposite directions as the shade is turned. As the shade elements 2 tilt the flaps 7 remain in a vertical orientation. Hence, the shade elements 2 could be said to fold relative to the flaps 7.

Lift cords 5 extend from the bottom rail 10 through the shade elements 2, through the headrail 6 and a cord lock 9 in the headrail. Pulling the lift cords 5 will raise the bottom rail 10 and shade elements 2. If desired the lift cords could be connected to the lowermost shade element and the bottom rail would then not be present. The lift cords 5 may pass through the center of the shade elements 2 or through loops extending from the first cords or the second cords. If desired one could wind the lift cords on a shaft within the headrail and use a motor or cord loop to rotate the shaft thereby raising or lowering the shade.

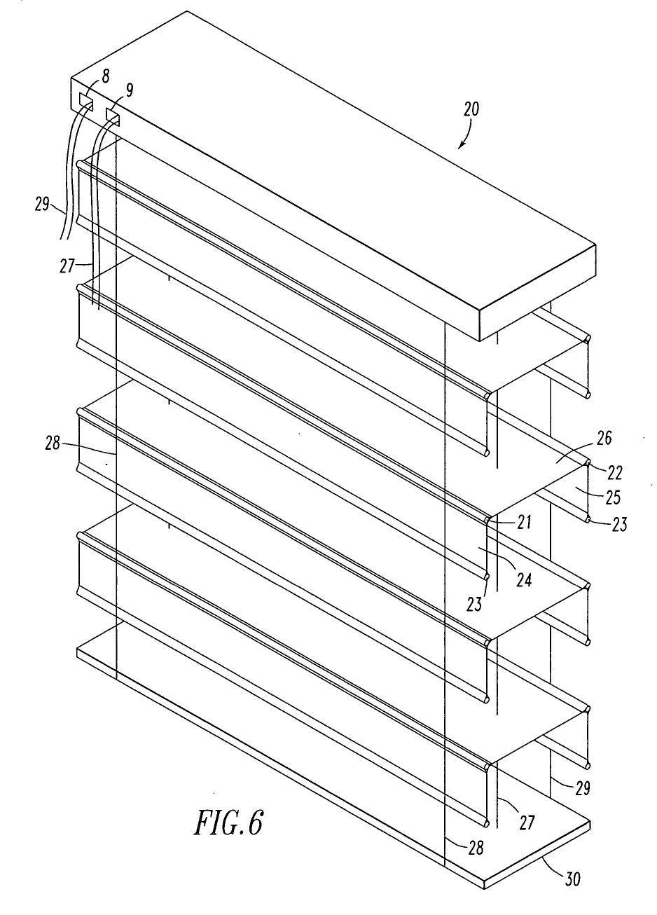

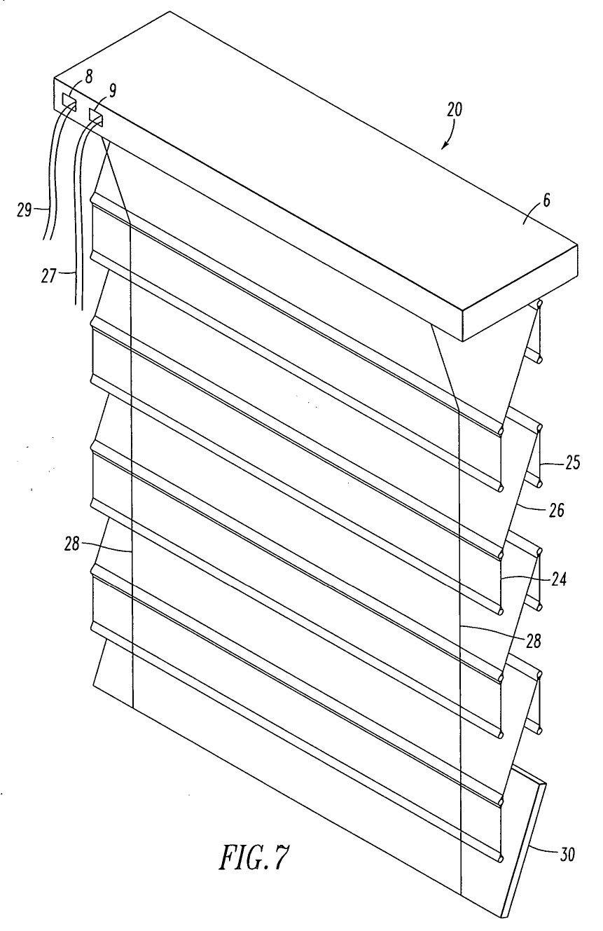

In the second present preferred embodiment 20 shown in FIGS. 6, 7 and 8, two flaps 24 and 25 are attached to each shade element 26. Each shade element has a stiffening rod 21 or 22 on each longitudinal edge. A stiffening rod 23 is also provided in the free edge of each flap 24, 25. Although both flaps 24 and 25 could be same material, I prefer that one flap 24 be an opaque material through which light does not pass and the second flap 25 be a mesh or other light transmissive material. Consequently, when the shade elements 26 are tilted to the position shown in FIG. 7, the opaque flaps 24 close the gaps between adjacent shade elements allowing little or no light to pass through the window covering. However, when the shade elements 26 are tilted in the opposite direction, shown in FIG. 8, the light transmissive flaps 25 will be between adjacent shade elements. Therefore, light may pass through the light transmissive flaps 25 between adjacent slats. Lift cords 27 extend from a bottom rail 30 through the shade elements and into the headrail 6. The lift cords 27 pass through a cord lock 9. Pulling the lift cords will raise the bottom rail 30 lifting the shade elements. As in the first embodiment, a first pair of cords 28 is attached to one edge of each shade element and a second pair of cords 29 is attached to the opposite edge of each shade element. These cords 28, 29 function in the same manner as cords 3 and 4 in the first embodiment.

Although I prefer that each flap 24, 25 be a single material having the same opacity throughout other variations are possible. Two or more materials could be used in a single flap such that one portion of the flap is a different opacity, color or texture than another portion of the flap. Both flaps may be a mesh fabric or other light transmissive material. When the flaps are positioned as in FIG. 6 it may or may not be possible to see through the flaps depending upon the weave of the flaps. The flaps may also be different colors as well as being light transmissive. The use of different colors, such as blue for one flap and yellow for the second flap, may cause the flaps to appear to be a third color, such as green, when the flaps are aligned as in FIG. 6. A similar effect may be achieved by placing a third flap (not shown) between the two flaps.

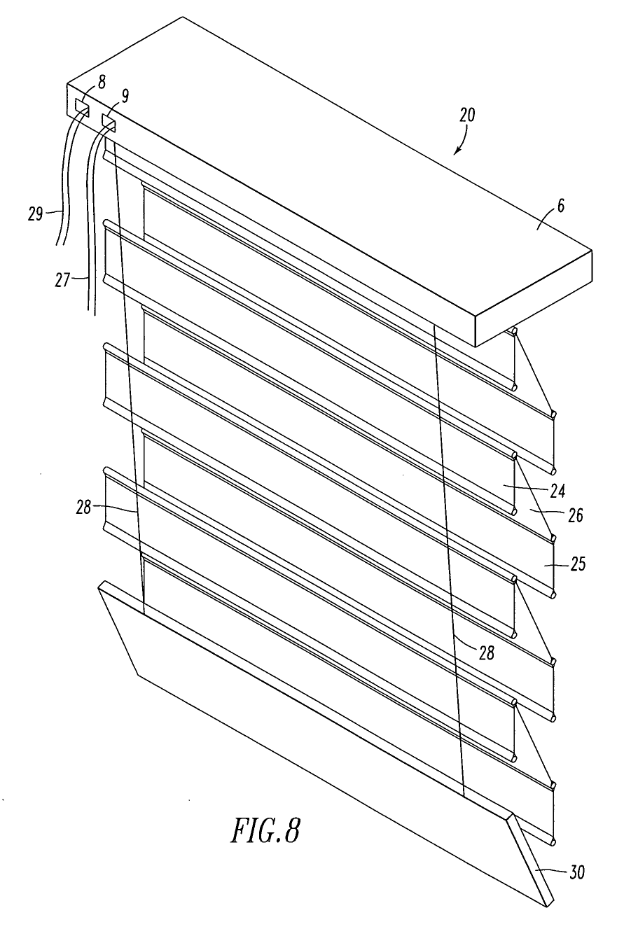

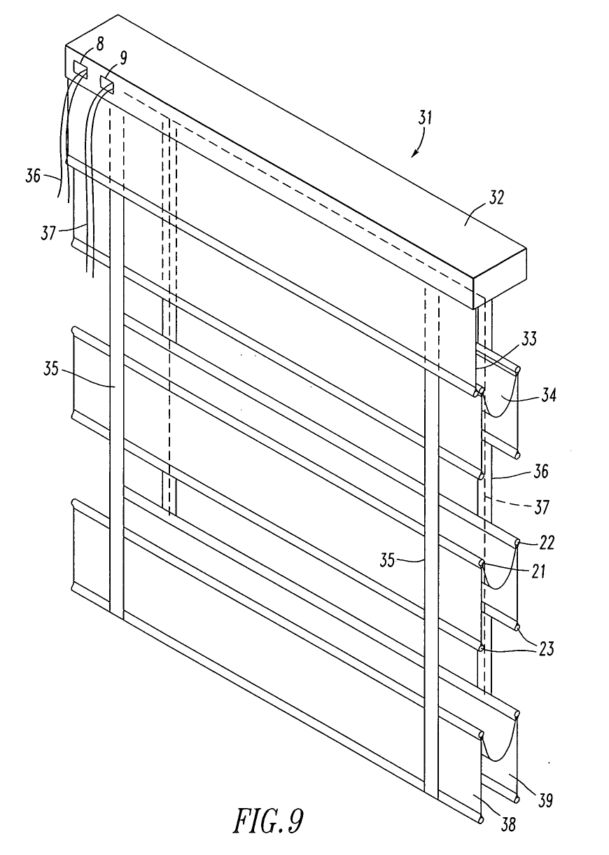

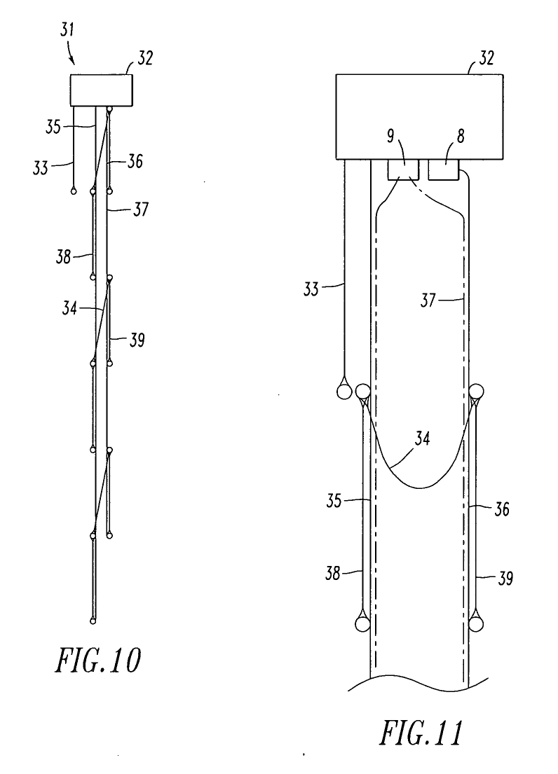

A third present preferred embodiment 31, shown in FIGS. 9, 10 and 11 has a narrow headrail 32 with a valance 33. Like the first embodiment this embodiment has a plurality of shade elements 34, first cords 35, second cords 36 and lift cords 37. Here cords 35 and 36 are fabric tape. Rods 21 and 22 are attached to the longitudinal edges of each shade element 34. As in the second embodiment, flaps 38 and 39 extend from the longitudinal edges of the shade elements 34. Each flap 38, 39 has a stiffening rod 23 on its free edge. Because of the narrow headrail and because the shade elements are fabric, the longitudinal edges of each shade element will be closer together when in a horizontal, plane as shown in FIGS. 9 and 11. Consequently, this embodiment has a relatively narrow profile. The headrail 32 may simply be a fabric-covered board having cord locks and pulleys attached to the bottom of the board behind the valances. This embodiment can be operated in the same manner as the previous embodiments depending upon whether the first cords or the second cords or neither the first cords nor second cords are fixed to the headrails. Pulling cords 36 will raise the second longitudinal edge of the shade elements to the position shown in FIG. 10. Pulling the first cords will raise the first longitudinal edge of the shade elements. When the first longitudinal edge is raised, flaps 39 will cover the gap between adjacent shade elements 34. If the second longitudinal edge is fully raised or the first longitudinal edge is lowered, then flaps 38 will be between adjacent shade elements. Preferably, flaps 38 do not allow light to pass and flaps 39 are a light transmissive material.

Any of the embodiments here disclosed could be corded to operate as a top down, bottom up blind. In such an embodiment the first cords and second cords would be movable such that all of the shade elements could be lowered onto a bottom rail or window sill. The cords would be connected to the shade elements in the same manner as in the embodiments shown in the drawings.

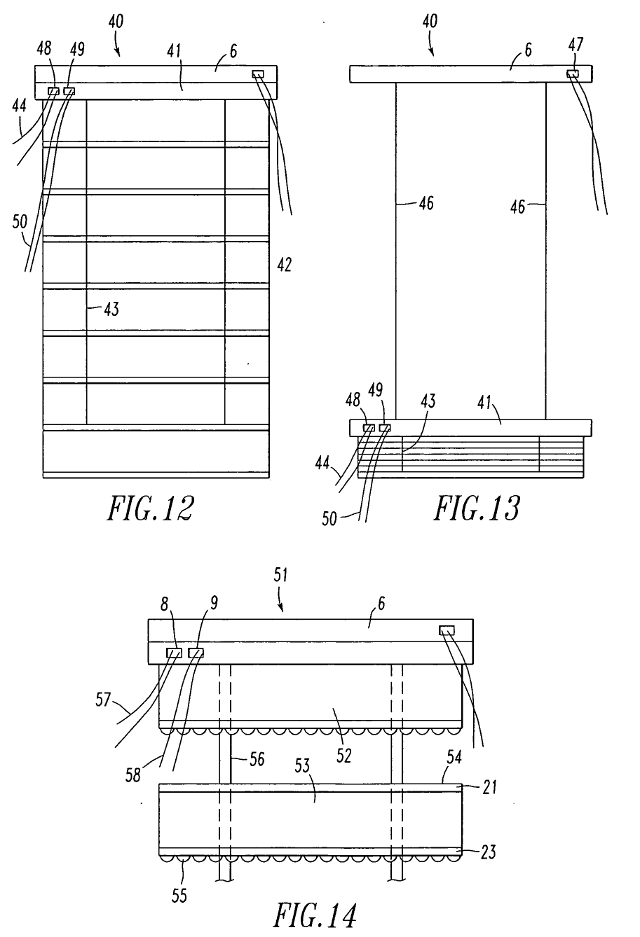

One could also provide top down bottom up capability through the use of another headrail or an intermediate rail as in the fourth embodiment 40 shown in FIGS. 12 and 13. In this embodiment, the shade elements 42 may be similar to any of the shade elements of the first three embodiments. First cords 43 are attached to the one longitudinal edge of each shade element and have their upper ends affixed to the intermediate rail 41. Second cords 44 are attached to the opposite longitudinal edge of each shade element and pass through the intermediate rail 41 and through a cord lock 48 at one end of the intermediate rail 41. Lift cords 50 extend from the lowermost shade element or bottom rail into the intermediate rail through cord lock 49. A second set of lift cords 46 is attached to the intermediate rail and passes through a cord lock 47 in the headrail 6. If desired, cord locks 48 and 49 could be positioned in the headrail 6 in which case cords 44 and 45 would pass through the intermediate rail and into the headrail. In either configuration the cords would operate the shade elements in the same way. Cords 46 are attached to the intermediate rail and pass through a cord lock 47 in the headrail. These cords permit the intermediate rail 41 to be raised and lowered.

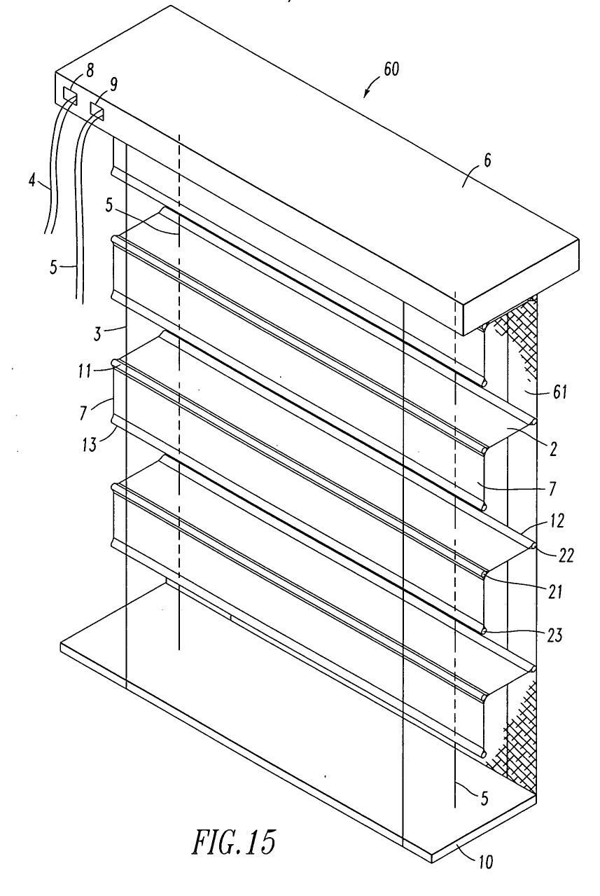

In all the embodiments described and illustrated to this point, the lower edge of every flap has been a straight line. However, such a configuration is not required. The bottom edge of one or more flaps could be curved, scalloped, or have another non-linear configuration. Moreover, a fringe could be attached to the bottom edge of one or more flaps. Another present preferred embodiment 51 shown in FIG. 14 has several shade elements 54 each having at least one flap 53. In this embodiment the lower edges 55 of each flap 53 are scalloped. As in the previous embodiments rods 21 are attached to each shade element adjacent to the upper edge and lower edge of each shade element. Since the lower edge 55 is scalloped rod 23 is positioned above the scallops. A valance 52 extends from the front of the headrail 6. First cords or tapes 56 are attached to the front edge of each shade element and have an upper end fixed to the headrail. Second cords 57 are attached to the opposite edge of each shade element and pass through cord lock 8. Lift cords 58 are attached to the lowermost shade element or bottom rail and pass through cord lock 9.

Each of the embodiments here disclosed has a pair of lift cords, a pair of first cords attached to one longitudinal edge of each shade element and a pair of second cords attached to the opposite longitudinal edge of each shade element. However, a single cord or more than two cords could be used in place of each pair of cords depending upon the size of the shade and the material used for the shade elements. One could use a tape or strip of fabric rather than a conventional cord material for the cords attached to the edges of the shade elements. Indeed, anything that functions in the same way as the cords shown in the preferred embodiment should be considered a cord for the purposes of this invention. The rods attached to the edges of the shade elements and flaps are preferably metal, but they could be plastic or fiberglass.

The headrail and bottom rail could be any configuration that is known in the art. Additionally, either or both of the headrail and the bottom rail could be covered with a fabric. This fabric may or may not be the same as the fabric used for the shade elements or a valance.

A seventh present preferred embodiment of my window covering 60, shown in FIG. 15, is similar to the embodiment of FIG. 1. Accordingly, similar components bear the same reference number. In this embodiment I provide a panel of mesh fabric 61 that extends from the bottom rail 10 to the headrail 6. This panel may or may not be attached to the longitudinal edges 12 of each shade elements 2. If the panel is attached to those edges, then the upper edge of the fabric could be attached to a shaft or roller within the headrail making cords 4 unnecessary. The longitudinal edges of the shade elements could be raised or lowered by simply rolling and unrolling the panel about the shaft or roller. If desired one could provide a second panel (not shown) on the opposite side of the window covering and adjacent to edges 11 of the shade elements 2. This panel may be used in place of or in addition to cords 3. One could also use one or two panels of mesh fabric in combination with the embodiments shown in FIGS. 6 through 14. The panel or panels would be connected between the headrail and the bottom rail in any of the same manners described here.

Although I have shown and described certain present preferred embodiments of my window covering having operable shade elements, it should be distinctly understood that the invention is not limited thereto, but may be variously embodied within the scope of the following claims.

I claim:

1. A window covering comprising:
a headrail;
a plurality of shade elements, each and every shade element having a length and a width, the length being greater than the width, wherein the width of each shade element is approximately equal to the width of all other shade elements, a first longitudinal edge and a second longitudinal edge, the shade elements positioned sequentially below the headrail and pairs of adjacent shade elements separated by a distance greater than the width of the shade elements;
a first cord attached to the first longitudinal edge of each shade element and extending from the headrail;
a second cord attached to the second longitudinal edge of each shade element and extending from the headrail;
a plurality of first flaps, each first flap having a first longitudinal edge attached to the first longitudinal edge of one of the plurality of shade elements, each flap having a length corresponding to the length of the plurality of shade elements, a width and a second longitudinal edge, the second longitudinal edge being a free edge; and
a control mechanism within the headrail and connected to at least one of the first cord and second cord.

2. The window covering of claim 1 also comprising a bottom rail positioned below the headrail and below the plurality of shade elements and a plurality of lift cords attached to the bottom rail and extending into the headrail.

3. The window covering of claim 1 also comprising a plurality of lift cords attached to the lowermost one of the plurality of shade elements and extending to the headrail.

4. The window covering of claim 1 also comprising a plurality of second flaps, each second flap having a first longitudinal edge attached to the second longitudinal edge of one of the plurality of shade elements, each second flap having a length corresponding to the length of the plurality of shade elements, a width and a second longitudinal edge, the second longitudinal edge being a free edge.

5. The window covering of claim 4 wherein the width of the plurality of first flaps is equal to the width of the plurality of second flaps.

6. The window covering of claim 4 wherein each of the plurality of second flaps is comprised of a sheer material.

7. The window covering of claim 4 wherein the plurality of first flaps each have an opacity greater than an opacity of the plurality of second flaps.

8. The window covering of claim 1 wherein the width of the plurality of first flaps is not less than the distance between adjacent shade elements.

9. The window covering of claim 1 wherein the control mechanism is comprised of a cord lock attached to the headrail and through which at least one of the first cord and second cord passes.

10. The window covering of claim 1 wherein the control mechanism is comprised of a shaft within the headrail on which one of the first cord and the second cord is wound.

11. The window covering of claim 10 also comprising a stiffening rod attached to one of the longitudinal edges of one of the shade elements.

12. The window covering device of claim 1 wherein the plurality of shade elements are each comprised of a material selected from the group consisting of woven fabrics, non-woven fabrics, films, woven woods and woven grasses.

13. The window covering of claim 1 also comprising:
a second headrail; and
a plurality of cords attached to the headrail and passing into the second headrail for raising and lowering the headrail relative to the second headrail.

14. The window covering of claim 13 also comprising a cord lock in the second headrail, the plurality of cords passing through the cord lock.

15. The window covering of claim 1 wherein the lower edge of the at least one flap is non-linear.

16. The window covering of claim 1 wherein the lower edge of the at least one flap is scalloped.

17. The window covering of claim 1 also comprising at least one panel of material extending from the headrail.

18. The window covering of claim 1 wherein the at least one panel of material is attached to the first longitudinal edge or the second longitudinal edge of at least one of the plurality of shade elements.

19. The window covering of claim 18 also comprising a bottom rail attached to the at least one panel of material.

20. A window covering comprising:
a headrail;
a plurality of shade elements, each and every shade element having a length and a width, the length being greater than the width, wherein the width of each shade element is approximately equal to the width of all other shade elements, a first longitudinal edge and a second longitudinal edge, the shade elements positioned sequentially below the headrail and pairs of adjacent shade elements separated by a distance greater than the width of the shade elements;
a first cord attached to the first longitudinal edge of each shade element and extending from the headrail;
a panel of material attached to the second longitudinal edge of each shade element and extending from the headrail;
a plurality of first flaps, each first flap having a first longitudinal edge attached to the first longitudinal edge of one of the plurality of shade elements, each flap having a length corresponding to the length of the plurality of shade elements, a width and a second longitudinal edge, the second longitudinal edge being a free edge; and
a control mechanism within the headrail and connected to at least one of the first cord and the panel of material.

21. The window covering of claim 20 also comprising a bottom rail positioned below the headrail and below the plurality of shade elements and a plurality of lift cords attached to the bottom rail and extending into the headrail.

22. The window covering of claim 20 also comprising a plurality of lift cords attached to the lowermost one of the plurality of shade elements and extending to the headrail.

23. The window covering of claim 20 also comprising a plurality of second flaps, each second flap having a first longitudinal edge attached to the second longitudinal edge of one of the plurality of shade elements, each second flap having a length corresponding to the length of the plurality of shade elements, a width and a second longitudinal edge, the second longitudinal edge being a free edge.

24. The window covering of claim 23 wherein the width of the plurality of first flaps is equal to the width of the plurality of second flaps.

25. The window covering of claim 23 wherein each of the plurality of second flaps is comprised of a sheer material.

26. The window covering of claim 23 wherein the plurality of first flaps each have an opacity greater than an opacity of the plurality of second flaps.

27. The window covering of claim 20 wherein the width of the plurality of first flaps is not less than the distance between adjacent shade elements.

28. The window covering of claim 20 wherein the control mechanism is comprised of a shaft within the headrail on which one of the first cord and the panel of material is wound.

29. The window covering of claim 20 also comprising a stiffening rod attached to one of the longitudinal edges of one of the shade elements.

30. The window covering device of claim 20 wherein the plurality of shade elements are each comprised of a material selected from the group consisting of woven fabrics, non-woven fabrics, films, woven woods and woven grasses.

31. The window covering of claim 20 wherein the lower edge of the at least one flap is non-linear.

32. The window covering of claim 20 wherein the lower edge of the at least one flap is scalloped.

33. A window covering comprising:
a headrail;
a plurality of shade elements, each and every shade element having a length and a width, the length being greater than the width, wherein the width of each shade element is approximately equal to the width of all other shade elements, a first longitudinal edge and a second longitudinal edge, the shade elements positioned sequentially below the headrail and pairs of adjacent shade elements separated by a distance greater than the width of the shade elements;
a first panel of material attached to the first longitudinal edge of each shade element and extending from the headrail;
a second panel of material attached to the second longitudinal edge of each shade element and extending from the headrail;
a plurality of first flaps, each first flap having a first longitudinal edge attached to the first longitudinal edge of one of the plurality of shade elements, each flap having a length corresponding to the length of the plurality of shade elements, a width and a second longitudinal edge, the second longitudinal edge being a free edge; and
a control mechanism within the headrail and connected to at least one of the first panel of material and the second panel of material.

34. The window covering of claim 33 also comprising a bottom rail positioned below the headrail and below the plurality of shade elements and a plurality of lift cords attached to the bottom rail and extending into the headrail.

35. The window covering of claim 33 also comprising a plurality of lift cords attached to the lowermost one of the plurality of shade elements and extending to the headrail.

36. The window covering of claim 33 also comprising a plurality of second flaps, each second flap having a first longitudinal edge attached to the second longitudinal edge of one of the plurality of shade elements, each second flap having a length corresponding to the length of the plurality of shade elements, a width and a second longitudinal edge, the second longitudinal edge being a free edge.

37. The window covering of claim 36 wherein the width of the plurality of first flaps is equal to the width of the plurality of second flaps.

38. The window covering of claim 36 wherein each of the plurality of second flaps is comprised of a sheer material.

39. The window covering of claim 36 wherein the plurality of first flaps each have an opacity greater than an opacity of the plurality of second flaps.

40. The window covering of claim 33 wherein the width of the plurality of first flaps is not less than the distance between adjacent shade elements.

41. The window covering of claim 33 wherein the control mechanism is comprised of a shaft within the headrail on which one of the first panel of material and the second panel of material is wound.

42. The window covering of claim 33 also comprising a stiffening rod attached to one of the longitudinal edges of one of the shade elements.

43. The window covering device of claim 33 wherein the plurality of shade elements are each comprised of a material selected from the group consisting of woven fabrics, non-woven fabrics, films, woven woods and woven grasses.

43. The window covering of claim 33 wherein the lower edge of the at least one flap is non-linear.

44. The window covering of claim 33 wherein the lower edge of the at least one flap is scalloped.
